(19) United States
(12) Patent Application Publication
(10) Pub. No.: US 2010/0141196 A1
(43) Pub. Date: Jun. 10, 2010

(54) GAIN VALUE CONTROL SYSTEM AND METHOD

(75) Inventor: HSIN-YEN CHAO, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: FOXNUM TECHNOLOGY CO., LTD., Tucheng City (TW)

(21) Appl. No.: 12/339,063

(22) Filed: Dec. 19, 2008

(30) Foreign Application Priority Data
Dec. 10, 2008 (CN) 200810306078.0

(51) Int. Cl. H02P 29/00

(52) U.S. Cl. 318/494

(57) ABSTRACT

A control system for controlling a plurality of gain values of a driver includes a control device, a driver, a motor, and a plurality of sensors. The control device stores a plurality of gain values for the driver, and a plurality of encoded values. One or more of encoded values is corresponding to each of the plurality of gain values. The plurality of sensors detect a plurality of working parameters of the motor to generating a plurality of induction signals. The control device generates an encoded value according to the plurality of induction signals to select a gain value for the driver.

### BACKGROUND

1. Technical Field

The present disclosure relates to control systems and methods and, particularly, to a control system and method for controlling a plurality of gain values of a driver according to working status of a motor.

2. Description of Related Art

Various gain values, such as current gain values and voltage gain values, of a driver are critically important for a performance of a motor. For example, current gain values of the driver can control input current for the motor. Most existing methods determine gain values of the driver based on a predetermined program. Thus, when working status of the motor abruptly change, it is difficult to adjust the gain values of the driver, which may cause damage to the motor.

What is needed, therefore, is to provide a control system and method that can overcome the aforementioned deficiencies.

### BRIEF DESCRIPTION OF THE DRAWINGS

FIG. 1 is a step diagram of an exemplary embodiment of a control system for controlling gain values of a driver according to the working status of a motor.

FIG. 2 is a flowchart of an exemplary embodiment of a control method for controlling gain values of a driver according to the working status of a motor.

### DETAILED DESCRIPTION

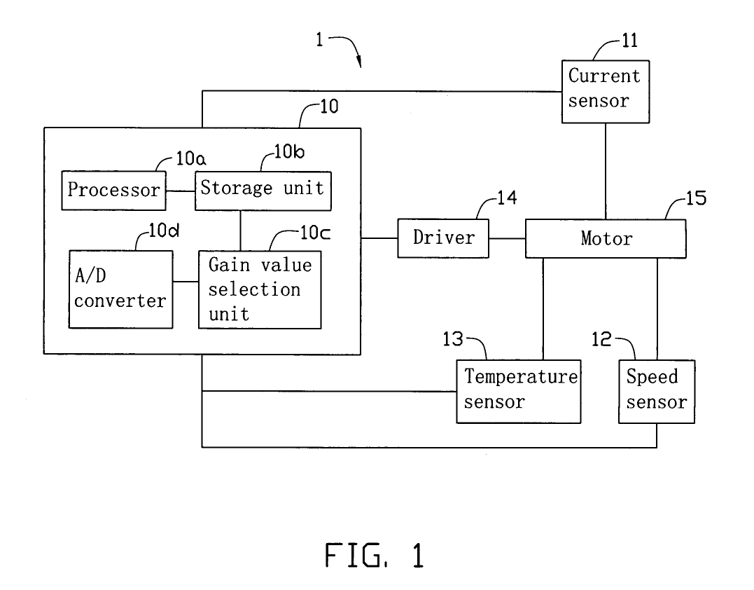

Referring to FIG. 1, an exemplary embodiment of a control system 1 for controlling a plurality of gain values of a driver 14 according to the working statue of a motor 15 may include a control device 10, a current sensor 11 connected between the control device 10 and the motor 15, a speed sensor 12 connected between the control device 10 and the motor 15, and a temperature sensor 13 connected between the control device 10 and the motor 15. The control device 10 may include a processor 10a, a storage unit 10b, a gain value selection unit 10c, and an analog-to-digital (A/D) converter 10d. In one embodiment, the gain value selection unit 10c selects a gain value in the storage unit 10b for the driver 14 through detecting working current, speed, and environment temperature of the motor 15 by the current, speed, and temperature sensors 11, 12, and 13. It can be understood that gain values herein can be various gain values, such as current gain values, voltage gain values, power gain values, and so on. Further details of elements and operations of the control system 1 will be described as follows.

The processor 10a is configured for dividing a gain value range of the driver 14 into a plurality of gain values, and for generating a plurality of encoded values according to the number of sensors. For example, the processor 10a divides a gain value range of the driver 14, such as [0 dB, 80 dB], into several gain values 20 dB, 35 dB, 50 dB, 60 dB, 75 dB, and 80 dB, for example. In one embodiment, the processor 10a generates eight encoded values, i.e., 000, 001, 010, 011, 100, 101, 110, and 111, corresponding to the current, speed, and temperature sensors 11, 12, and 13. Each gain value can be corresponding to one or more of encoded values. For example, the gain value 80 dB is corresponding to the encoded values 000, 001, 010, and the gain value 20 dB is corresponding to the encoded value 111. It can be understood that the division manners of a gain range of the driver 14 can be random. In general, for efficiently controlling the working statue of the motor 15, the smaller the encoded values the smaller the corresponding gain values, and the number of gain values is no more than the number of the encoded values. The storage unit 10b is configured for storing the gain values for the driver 14, and the encoded values, such as 20 dB, 35 dB, 50 dB, 60 dB, 75 dB, 80 dB, 000,001, 010, 011, 100, 101, 110, and 111.

The current sensor 11 is configured for detecting the working current of the motor 15 to generate a current analog induction signal. The speed sensor 12 is configured for detecting speed of the motor 15 to generate a speed analog induction signal. The temperature sensor 13 is configured for detecting environment temperature of the motor 15 to generate a temperature analog induction signal. It can be understood that other type sensors, such as voltage sensor, can be also used in the control system 1, and the combinations of sensors can be changed. The A/D converter 10d is configured for converting analog induction signals to corresponding digital induction signals according to preset threshold values. In one embodiment, if the peak of a current analog induction signal is greater than a preset current threshold value, such as 1.5 A, the A/D converter 10d converts the current analog induction signal to a current digital induction signal denoted as 1. If the peak of a current analog induction signal is no more than the preset current threshold value 1.5 A, the current digital induction signal is denoted as 0. The conversion processes for the speed and temperature analog induction signals by the A/D converter 10d are similar with the conversion process for the current analog induction signal. Therefore, the current, speed, and temperature digital induction signals can be constituted as a three-bit encoded value. For example, when the current, speed, and temperature analog induction signals are all lower than their corresponding preset threshold values, the three-bit encoded value is denoted as 000.

The gain value selection unit 10c is configured for selecting a gain value for the driver 14 in the storage unit 10b according to the encoded value generated by the A/D converter 10d. In one embodiment, the gain value selection unit 10c selects the gain value 80 dB when the encoded value generated by the A/D converter 10d is 000, for example. The processor 10a controls the driver 14 to work according to the selected gain value, such as 80 dB.

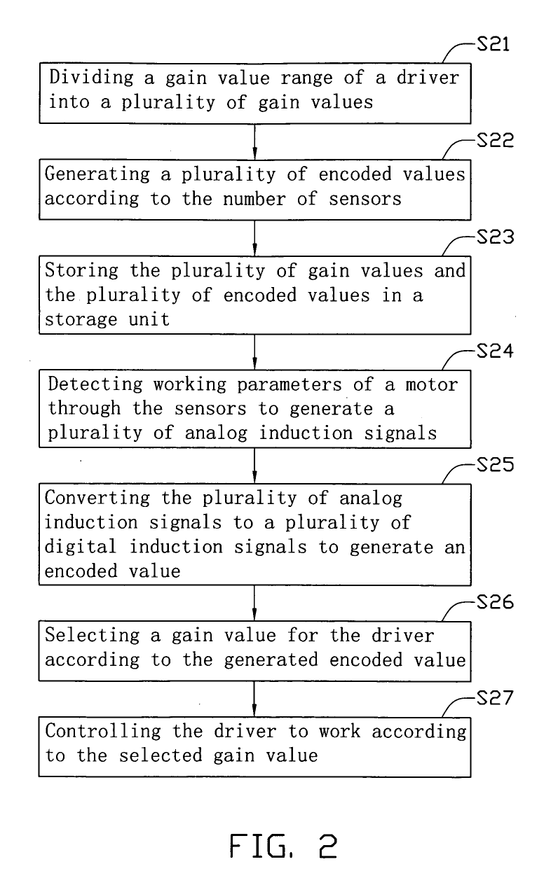

Referring to FIG. 2, an embodiment of a control method for controlling a plurality of gain values of the driver 14 according to working status of the motor 15, such as working current, speed, and environment temperature in one embodiment.

In step S21, the processor 10a divides a gain value range of the driver 14 into a plurality of gain values.

In step S22, the processor 10a generates a plurality of encoded values according to the number of sensors, such as sixteen four-bit encoded values 0000-1111 in responding to four sensors.

In step S23, the storage unit 10b stores the plurality of gain values for the driver and the plurality of encoded values, wherein each of the plurality of gain values can be corresponding to one or more of the plurality of encoded values.

In step S24, the current, speed, and temperature sensors 11, 12, and 13 detect working current, speed, and environment temperature of the motor 15 respectively to correspondingly generate a current analog induction signal, a speed analog induction signal, and a temperature analog induction signal.

In step S25, the A/D converter 10d convert the current, speed, and temperature analog induction signals to corresponding current, speed, and temperature digital induction signals according to preset current, speed, and temperature threshold values. Accordingly, the current, speed, and temperature digital induction signals are constituted as a generated encoded value.

In step S26, the gain value selection unit 10c selects a gain value for the driver 14 in the storage unit 10b according to the generated encoded value.

In step S7, the processor 10a controls the driver 14 to work according to the selected gain value.

The foregoing description of the certain inventive embodiments of the disclosure has been presented only for the purposes of illustration and description and is not intended to be exhaustive or to limit the disclosure to the precise forms disclosed. Many modifications and variations are possible in light of the above everything. The embodiments were chosen and described in order to explain the principles of the disclosure and their practical application so as to enable others of ordinary skill in the art to utilize the disclosure and various embodiments and with various modifications as are suited to the particular use contemplated. Alternative embodiments will become apparent to those of ordinary skill in the art to which the present disclosure pertains without departing from its spirit and scope. Accordingly, the scope of the present disclosure is defined by the appended claims rather than the foregoing description and the embodiments described therein.

What is claimed is:

1. A control system for controlling a plurality of gain values of a driver, the control system comprising:
a storage unit for storing the plurality of gain values for the driver and a plurality of encoded values, wherein each of the plurality of gain values can be corresponding to one or more of the plurality of encoded values;
a plurality of sensors configured for detecting a plurality of working parameters of a motor driven by the driver, and for generating a plurality of analog induction signals, wherein each of the plurality of analog induction signals is corresponding to one of the plurality of working parameters;
an analog-to-digital converter configured for converting the plurality of analog induction signals to a plurality of digital induction signals according to corresponding preset threshold values, wherein the plurality of digital induction signals are constituted as a generated encoded value;
a gain value selection unit configured for selecting a gain value for the driver in the storage unit according to the generated encoded value; and
a processor configured for controlling the driver to work according to the selected gain value, for dividing a gain value range of the driver into the plurality of gain values, and for generating the plurality of encoded values according to the number of the plurality of sensors.

2. The control system of claim 1, wherein the plurality of sensors comprise a current sensor for detecting working current of the motor to generate a current analog induction signal, a temperature sensor for detecting environment temperature to generate a temperature analog induction signal, and a speed sensor for detecting speed of the motor to generate a speed analog induction signal.

3. The control system of claim 1, wherein the plurality of sensors comprise a voltage sensor for detecting working voltage of the motor to generate a voltage analog induction signal, a temperature sensor for detecting environment temperature to generate a temperature analog induction signal, and a speed sensor for detecting speed of the motor to generate a speed analog induction signal.

4. A control method for controlling a plurality of gain values of a driver through applying in a control system having a processor, a storage unit, a plurality of sensors, an analog-to-digital (A/D) convertor, and a gain value selection unit, the control method comprising:
storing the plurality of gain values for the driver and a plurality of encoded values in the storage unit, wherein each of the plurality of gain values can be corresponding to one or more of the plurality of encoded values;
detecting a plurality of working parameters of a motor driven by the driver through the plurality of sensors;
generating a plurality of analog induction signals through the plurality of sensors, wherein each of the plurality of analog induction signals is corresponding to one of the plurality of working parameters;
converting the plurality of analog induction signals to a plurality of digital induction signals through the A/D converter, wherein the plurality of digital induction signals are constituted as a generated encoded value;
selecting a gain value for the driver in the storage unit through the gain value selection unit according to the generated encoded value; and
controlling the driver to work through the processor according to the selected gain value.

5. The control method of claim 4, wherein before the storing step, the control method further comprises:
dividing a gain value range of the driver into the plurality of gain values through the processor; and
generating the plurality of encoded values according to the number of the plurality of sensors through the processor.

6. The control method of claim 4, wherein the step of generating a plurality of analog induction signals comprises:
detecting working voltage of the motor and generating a voltage analog induction signal through a voltage sensors;
detecting environment temperature and generating a temperature analog induction signal through a temperature sensors;
detecting speed of the motor and generating a speed analog induction signal through a speed sensors; and
converting the voltage, temperature, and speed analog induction signals to the voltage, temperature, and speed digital induction signals through the A/D converter.

7. The control method of claim 4, wherein the step of generating a plurality of analog induction signals comprises:
detecting working current of the motor and generating a current analog induction signal through a current sensors;
detecting environment temperature and generating a temperature analog induction signal through a temperature sensors;
detecting speed of the motor and generating a speed analog induction signal through a speed sensors; and
converting the current, temperature, and speed analog induction signals to the current, temperature, and speed digital induction signals through the A/D converter.

8. A computer-readable medium (CRM) having stored thereon instructions that is applied in a control system having a processor, a storage unit, a plurality of sensors, an analog-to-digital (A/D) convertor, and a gain value selection unit, when executed by a computer, cause the computer to:
store the plurality of gain values for the driver and a plurality of encoded values in the storage unit, wherein each of the plurality of gain values can be corresponding to one or more of the plurality of encoded values;
detect a plurality of working parameters of a motor drove by the driver through the plurality of sensors;
generate a plurality of analog induction signals through the plurality of sensors, wherein each of the plurality of analog induction signals is corresponding to one of the plurality of working parameters;
convert the plurality of analog induction signals to a plurality of digital induction signals through the A/D converter, wherein the plurality of digital induction signals are constituted as a generated encoded value;
select a gain value for the driver in the storage unit through the gain value selection unit according to the generated encoded value; and
control the driver to work through the processor according to the selected gain value.

9. The CRM of claim 8, wherein before storing the plurality of gain values for the driver and a plurality of encoded values in the storage unit, the CRM causes the computer to:
divide a gain value range of the driver into the plurality of gain values through the processor; and
generate the plurality of encoded values according to the number of the plurality of sensors through the processor.

10. The CRM of claim 8, wherein the CRM further causes the computer to:
detect working voltage of the motor and generate a voltage analog induction signal through a voltage sensors;
detect environment temperature and generate a temperature analog induction signal through a temperature sensors;
detect speed of the motor and generate a speed analog induction signal through a speed sensors; and
convert the voltage, temperature, and speed analog induction signals to the voltage, temperature, and speed digital induction signals through the A/D converter.

11. The CRM of claim 8, wherein the CRM further causes the computer to:
detect working current of the motor and generate a current analog induction signal through a current sensors;
detect environment temperature and generate a temperature analog induction signal through a temperature sensors;
detect speed of the motor and generate a speed analog induction signal through a speed sensors; and
convert the current, temperature, and speed analog induction signals to the current, temperature, and speed digital induction signals through the A/D converter.
